(19) United States
(12) Patent Application Publication
(10) Pub. No.: US 2007/0219029 A1
(43) Pub. Date: Sep. 20, 2007

(54) Fluid dampening chain tensioning device

(75) Inventor: Paul H. Turner, Aspen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Maverick American LLC, Boulder, CO (US)

(21) Appl. No.: 11/377,602

(22) Filed: Mar. 15, 2006

(51) Int. Cl. F16H 59/00; F16H 9/00; F16H 61/00

(52) U.S. Cl. 474/80; 474/69

(57) ABSTRACT

In one embodiment, a chain tensioning system is provided which maintains tension on a chain and permits slow changes in chain tension while dampening sudden changes. An exemplary embodiment may permit slow changes in chain tension while dampening sudden changes through the use of a fluid dampening device. Additionally, some embodiments may permit slow changes in chain tension while dampening sudden changes in only one direction of chain tension change.

### BACKGROUND OF THE INVENTION

This invention relates generally to the field of chain transmission systems. More specifically, the invention relates to fluid dampening chain tensioning systems for recreational wheeled vehicles and other devices employing a chain transmission.

The use of chain tensioning systems in chain transmission systems is widespread. Often a spring biased link arm is used in such systems to take up extra chain slack. Where such systems employ multi-ratio transmissions, the use of chain tensioning systems is even more widespread. The switching of a chain between different sprockets in multi-ratio chain transmission systems require accounting for extra slack in the chain after switching to smaller sprockets and allowing for extra slack in the chain when switching to larger sprockets.

These systems work well if the transmission is stationary or riding in a vehicle on a generally flat surface. However, once such vehicles encounter rough terrain, external forces can cause the link arms in these systems to over-rotate allowing the chain to slack excessively. This may cause the chain to fall off the sprockets or physically impact other portions of the chain transmission system. Such events can cause undesired operation including noise or even damage to the system. Simply increasing the biasing force on the link arm can reduce undesired over-rotation, but has the detrimental effect of increasing friction and between the sprocket and chain which causes accelerated system wear. The systems of the present invention provide solutions to these and other issues.

### BRIEF SUMMARY OF THE INVENTION

In one embodiment, the invention provides a chain tensioning system. The chain tensioning system has a chain tensioning device that is configured to maintain tension on a chain and a fluid dampening device operably coupled to the chain tensioning device. The chain tensioning device is used to maintain tension on the chain, and the fluid dampening device is configured to permit slow movement of the chain tensioning device while dampening sudden movement.

In such an embodiment, the chain tensioning device may have a link arm assembly having at least one pulley which engages the chain and a spring configured to apply a force to the link arm assembly. In one aspect, the fluid dampening device may have a knuckle boss which defines an annular groove that is used to hold a fluid and a stationary web within the annular groove. Furthermore, a flange may be provided that covers the annular groove. The chain tensioning device may be operably coupled to the flange so as to rotate and thus vary the tension on the chain.

In one particular aspect, a revolving web may be attached to the flange and disposed within the annular groove. In this way, as the flange rotates, the revolving web rotates through the annular groove. In some cases, the revolving web and the stationary web may form at least two chambers within the annular groove. Furthermore, the stationary web and the revolving web may define a fluid path that is configured to allow the fluid to flow from one of the chambers to at least one of the other chambers as the revolving web rotates through the annular groove. The size and other characteristics of the fluid path limit the flow of fluid from one chamber to another, thereby limiting the rotational speed of the flange and thus of the chain tensioning device.

A wide variety of fluid paths may be employed. Merely as an example, the fluid path may include one or more of the following: a cavity through either the stationary or revolving web; a breach around either the stationary or revolving web; a one-way valve disposed across a cavity through either the stationary or revolving web; or a one-way valve disposed across a breach around either the stationary or revolving web. These fluid paths may be configured so as to permit slow movement of the chain tensioning device while dampening sudden movement in one direction only.

In one aspect, the chain tensioning device of the chain tensioning system may be coupled to a single-ratio chain transmission. In another aspect, the chain tensioning device may be coupled to a multi-ratio chain transmission. In yet another possible aspect, the chain tensioning device may be coupled to a mounting boss which may be used to couple the chain tensioning system to a bicycle frame.

In another embodiment, a chain tensioning system is provided and may further have a derailleur coupled to a chain tensioning device and configured to move a chain between different sprockets when operated by a user. The derailleur may have a link arm assembly having at least one pulley which engages the chain and an articulator coupled to the link arm assembly. The articulator is configured to move the link arm, which in turn moves the chain between different sprockets. The articulator may have a cable operated by the user and a parallelogram linkage operably coupled to the cable. The parallelogram linkage may be configured to move the link arm when a tensile force is applied to or removed from the cable by the user.

In another embodiment of the invention, a chain derailleur tensioning system is provided. The chain derailleur tensioning system may include a derailleur configured to move a chain between different sprockets, and a chain tensioning device coupled to the derailleur. The chain tensioning device is configured to maintain tension on the chain. In this embodiment, a fluid dampening device is operably coupled to the chain tensioning device and is used to permit slow movement of the chain tensioning device while dampening sudden movement.

In another embodiment, a chain tensioning system is provided. The chain tensioning system has a means for maintaining tension on a chain and a means for permitting slow changes in chain tension while dampening sudden changes in chain tension. Such an embodiment may also provide means for moving the chain between different sprockets in a chain transmission system. Other embodiments may provide means for permitting slow changes in chain tension while dampening sudden changes in chain tension in one direction only.

Finally, in another embodiment of the invention, a fluid dampening system consisting of a fluid dampening device coupleable to a chain tensioning device is provided. A chain tensioning device may be any device configured to maintain tension on a chain. The fluid dampening device, when coupled with the chain tensioning device, may be configured to permit slow movement of the chain tensioning device while dampening sudden movement. Merely by way of example, the fluid dampening device may be coupleable to the chain tensioning device by coupling a rotational flange on the fluid dampening device to the chain tensioning device.

### BRIEF DESCRIPTION OF THE DRAWINGS

The present disclosure is described in conjunction with the appended figures:

FIG. 1 is an isometric view of a chain tensioning system coupled to a derailleur and a mounting boss;

FIG. 2 illustrates an exploded view of the system in FIG. 1;

FIG. 3 is a cross sectional view of a fluid dampening device used to dampen sudden changes in chain tension in one direction only during operation in that direction;

FIG. 4A is a cross sectional view of the fluid dampening device in FIG. 3 during operation in the opposite direction;

FIG. 4B is a cross sectional view of a fluid dampening device similar to that FIG. 4A, except having a breach around the revolving web and a cavity with a one-way valve in the stationary web;

FIG. 4C is a cross sectional view of a fluid dampening device similar to that FIG. 4A, except having a breach around both the revolving web and the stationary web, with a one-way valve disposed across the breach around the stationary web;

FIG. 4D is a cross sectional view of a fluid dampening device similar to that FIG. 4A, except having a breach around both the revolving web and the stationary web, with a one-way valve disposed across the breach around the revolving web;

FIG. 5 is an isometric view of a chain derailleur tensioning system coupled to a bicycle with a multi-ratio transmission system; and

FIG. 6 is an isometric view of a chain derailleur tensioning system coupled to a bicycle with a single-ratio transmission system.

In the appended figures, similar components and/or features may have the same reference label. Further, various components and/or features of the same type may be distinguished by following the reference label by a letter that distinguishes among the similar components and/or features. If only the first reference label is used in the specification, the description is applicable to any one of the similar components and/or features having the same first reference label irrespective of the letter suffix.

### DETAILED DESCRIPTION OF THE INVENTION

One embodiment of the invention provides a chain tensioning system having a chain tensioning device and a fluid dampening device. In such an embodiment, the chain tensioning device maintains tension on a chain and the fluid dampening device permits slow movement of the chain tensioning device while dampening sudden movement.

The chain tensioning device may consist of a link arm assembly that has a pulley which engages the chain. A spring may be used to apply force to the link arm assembly, thereby rotating the link arm assembly, reducing slack in the chain, and maintaining chain tension.

In some embodiments, the fluid dampening device may consist of two enclosed chambers, each containing a fluid. A fluid path may exist between the two chambers allowing the fluid to move from one chamber to the other. The fluid dampening device may have a rotating component that is operably coupled to the chain tensioning device. As the chain tensioning device moves, the rotating component of the fluid dampening device may rotate and make one of the chambers smaller and the other larger. This rotation may force the fluid to flow from the former chamber to the later chamber. The characteristics of both the fluid and the fluid path in such an embodiment determine how quickly the fluid flows between the chambers and consequently how quickly the chain tensioning device may move and adjust chain tension. For example, for any given fluid, a larger fluid path will allow for quicker fluid flow than a smaller fluid path, allowing for quicker rotation of the chain tensioning device. Likewise, for any given fluid path configuration, a less viscous fluid will flow more quickly through the fluid path than a more viscous fluid, allowing for quicker rotation of the chain tensioning device. Other fluid characteristics such as compressibility, and fluid path characteristics such as shape, may affect fluid flow rates and consequently the performance characteristics of the fluid dampening device.

Merely by way of example, the fluid path may consist of one or more cavities, orifices or breaches between the two chambers. Additionally, a valve may be disposed across one or more of the fluid paths so as to allow flow of the fluid in one direction only. In an embodiment with two or more fluid paths and a one-way valve disposed across one of the fluid paths, fluid will be able to flow in one direction more quickly than in the other. This may permit slow movement of the chain tensioning device in either direction, and substantial dampening of sudden movement in one direction only.

The chain tensioning systems of the invention may be employed in various systems. Merely by way of example, the chain tensioning systems may be coupled to single-ratio chain transmissions, such as those on a bicycle using a Pete Geigle Single-ator™ or a Surly Singleator™. The chain tensioning systems may also be coupled to multi-ratio transmissions. If the chain tensioning systems are coupled to a bicycle, they may employ a mounting boss, or other attachment mechanism, to attach the chain tensioning systems to the bicycle's frame.

Fluid dampening may be superior to frictional dampening when used in chain tensioning systems. Frictional dampening has two frictional components, static friction and dynamic friction. Static friction is usually larger than dynamic friction, meaning that movements in a frictionally dampened system will, on average, be opposed with more force when the movements are short and/or sporadic, and less force when the movements are longer and/or continuous. Fluid dampening systems provide more consistent dampening for both types of movements. Depending on characteristics of the fluid used, such as compressibility and viscosity, fluid dampening may even be able to increase as movements become quicker and/or more continuous. This is an effect opposite that produced by frictional dampening, and one that may be advantageous in chain tensioning systems.

In another aspect of the invention, a derailleur may be provided. The derailleur may be coupled to the chain tensioning device and, when operated by a user, be configured to move the chain between different sprockets. The derailleur may have a link arm assembly to engage the chain and an articulator configured to move the link arm. The articulator may be a parallelogram linkage operated by a cable which is in turn operated by a user. When tensile force is applied to or removed from the cable by the user, the linkage moves the link arm assembly, and consequently, the chain between different sprockets.

In another embodiment of the invention, a fluid dampening system is provided. The system may consist of a fluid dampening device coupleable to a chain tensioning device. The fluid dampening system in this embodiment may be an after-market system coupleable to an existing chain tensioning device. In one possible example, a user may purchase such a damping system and couple it to an existing chain tensioning device to improve performance of the chain tensioning device. The chain tensioning device may, merely by way of example, be any device configured to maintain tension on a chain, possibly in single-ratio or multi-ratio chain transmission systems. The fluid dampening device, when coupled with the chain tensioning device, may be configured to permit slow movement of the chain tensioning device while dampening sudden movement. The fluid dampening device may be coupleable to the chain tensioning device through a variety of techniques, including, but not limited to, coupling a rotational flange on the fluid dampening device to the chain tensioning device.

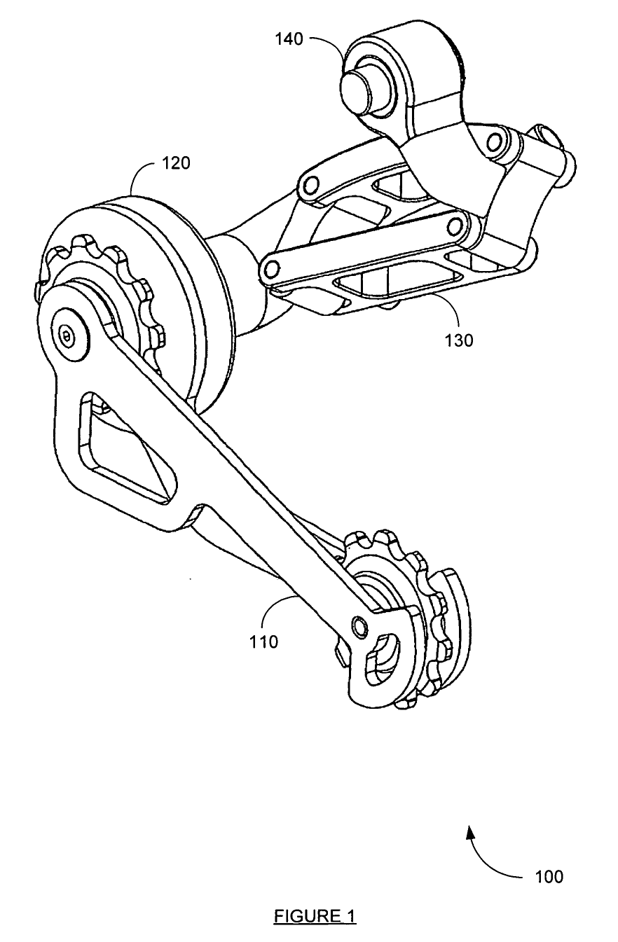

Referring now to FIG. 1, one possible embodiment of the chain tensioning system 100 is shown. In this embodiment a chain tensioning device 110 is operably coupled to a fluid dampening device 120. Additionally, a derailleur 130 is shown coupled to the chain tensioning system 100. Furthermore, this possible embodiment shows a mounting boss 140 which may be used to couple the chain tensioning system 100 to a bicycle frame. Other methods of attachment to the bicycle frame, both temporary and permanent, are possible, including, but not limited to, welding or clamps.

When coupled to a bicycle, the system described above provides tension on a chain in a chain transmission system, of the type that may commonly be employed on bicycles. The system insures that the chain is not too loose and does not disengage from the chain transmission system. For example, when the derailleur 130 is employed by a user to change to different sized sprockets in a multi-ratio chain transmission, the system will maintain chain tension. When the chain is switched to smaller sized sprockets, less chain is required to complete a loop between the sprockets and extra chain slack will appear in the system. The chain tensioning device 110 remedies this by applying extra tension to the chain, effectively taking up the extra slack. When a transition to larger sprockets is made, the chain tensioning device 110 removes tension from the system, effectively allowing the extra slack necessary for larger sprockets.

When a bicycle or other device using the above embodiment encounters rough terrain, the forces present upon the bicycle may overcome the inertia of the chain tensioning device 110 and cause the device to temporarily allow too much slack in the chain transmission system. However, the fluid dampening device 120 ameliorates this problem by dampening this sudden movement of the chain tensioning system, without requiring that stronger, system damaging, biasing springs be used in the chain tensioning device 110.

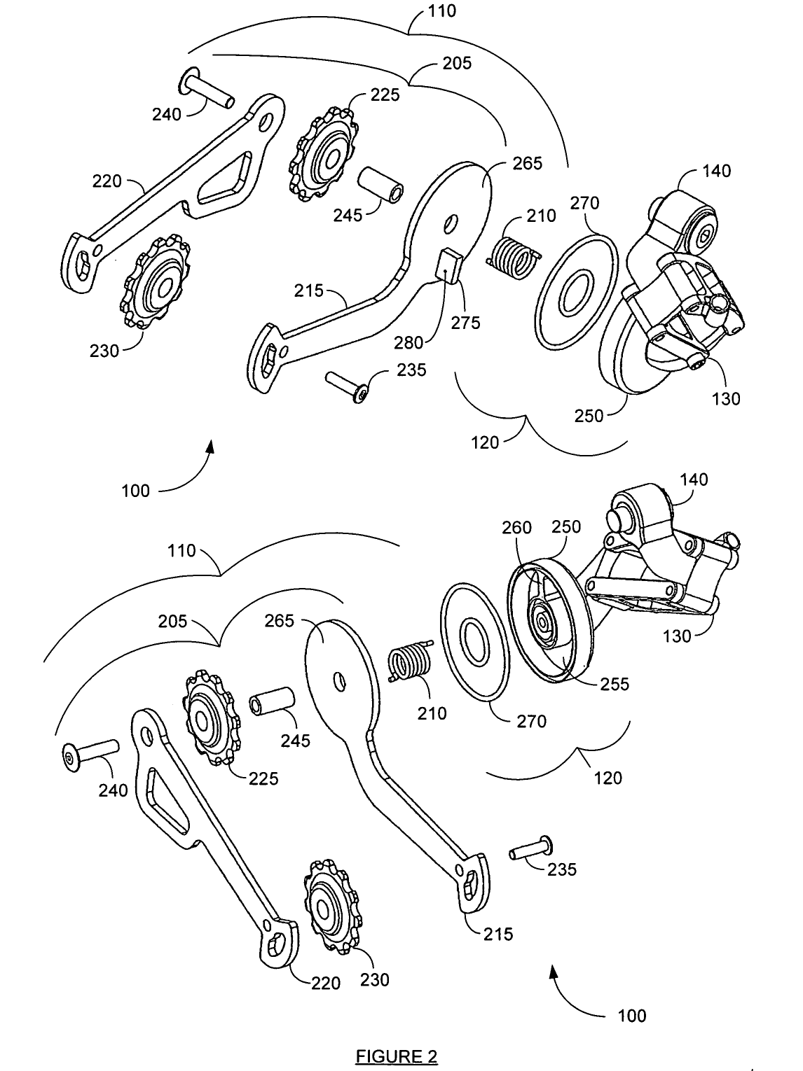

Referring to FIG. 2, chain tensioning device 110 and fluid dampening device 120 are shown disassembled from two angles. The chain tensioning device 110 may include a link arm assembly 205 and a spring 210. The link arm assembly 205 may be constructed of multiple parts such as two structural members 215, 220, two pulleys 225, 230, two pins 235, 240, and a bushing 245. The spring 210 may provide the force necessary for the chain tensioning device 110 to maintain tension on a chain. While a torsion spring is shown in FIG. 2, other types of springs, well known in the art, could serve the same purpose in similar or varying arrangements.

The fluid dampening device 120 may be constructed of a knuckle boss 250 which defines an annular groove 255 in which a fluid is located. A wide variety of fluids may be used, including those having different viscosities and compressibilities, such as oil, water, silicon fluid, and the like. Within the annular groove 255 may be a stationary web 260. A flange 265, which in this embodiment is part of the link arm assembly 205, covers and seals the annular groove 255, possibly using o-rings 270, and in this embodiment serves to couple the chain tensioning device 110 to the fluid dampening device 120. A revolving web 275 may be attached to the flange 265 so as to reside within the annular groove 255. The revolving web 275 and the stationary web 260 may form two chambers within the annular groove 255. A fluid path 280 for the fluid residing in the annular groove 255 to move between the two chambers formed by the stationary web 260 and the revolving web 275 may also be provided. The parts described above may be constructed from various materials, including, but not limited to, steel, aluminum, titanium or other alloys, polymers, ceramics or composites.

As the link arm assembly 205 rotates, and consequently the flange 265 rotates, the revolving web 275 rotates through the annular groove 255. The fluid in one of the chambers formed by stationary web 260 and the revolving web 275 is thereby forced from one chamber to the other through the fluid path 280. In this embodiment, the fluid may only proceed through the fluid path 280 in revolving web 275 at a certain rate. The fluid flow rate may be determined by the size of the fluid path 280, and the viscosity and compressibility of the fluid, among other factors.

In exemplary embodiments, the ratio between the cross sectional area of the annular groove (the “swept area”) to the cross sectional area of the fluid path may be greater than about 300-to-1. In preferred embodiments, the cross sectional area of the swept area to the cross sectional area of the fluid path may be about from 300-to-1 up to 400-to-1. In some embodiments, the viscosity of the fluid may be less than about 125 centipoise at 20° C. or that of SAE 20 weight motor oil.

The limitation on fluid flow rate restricts the link arm assembly 205 from rotating faster than the fluid may flow through the fluid path 280. It is appreciable to those skilled in the art that the fluid path 280 could also exist through the stationary web 260 and perform the same function. Likewise, while the fluid path 280 in this embodiment is shown as a cavity through the revolving web 275, other fluid path configurations are also possible. A breach, either around the stationary web 260 or the revolving web 275, could be provided by under-sizing the webs in relation to the cross-sectional shape of the annular groove 255. Such embodiments would allow for fluid flow around the webs in a manner similar to that described above, and having similar effects.

FIG. 2 also shows the derailleur 130 coupled to the chain tensioning device 110, fluid dampening device 120 and mounting boss 140. The mounting boss 140 may be used to couple the chain tensioning system 100 to a bicycle frame. In this embodiment, the system works as described to provide fluid dampened chain tensioning during the operation of the bicycle, while also allowing the bicycle's user to move the chain between sprockets.

Some embodiments may have at least two fluid paths and dispose a one-way valve across one of the fluid paths. In these embodiments fluid will flow through all fluid paths when the revolving web rotates in one direction. However, in the opposite direction of rotation, fluid may not flow through the fluid path across which a one-way valve is disposed. Such embodiments may allow for more significant dampening in one rotational direction of the link arm assembly than the other. In the described embodiment, that rotational direction would be the direction during which the one-way valve does not open. Embodiments employing a one-way valve may provide substantial dampening in one rotational direction only. The fluid path across which a one-way valve is disposed may allow for proportionally more flow than the non-valved fluid paths in such embodiments. The one-way valve in all of these embodiments may be a spring check valve, a ring check valve, a swing check valve, a fish mouth valve, a leaf valve or any other suitable one-way valve.

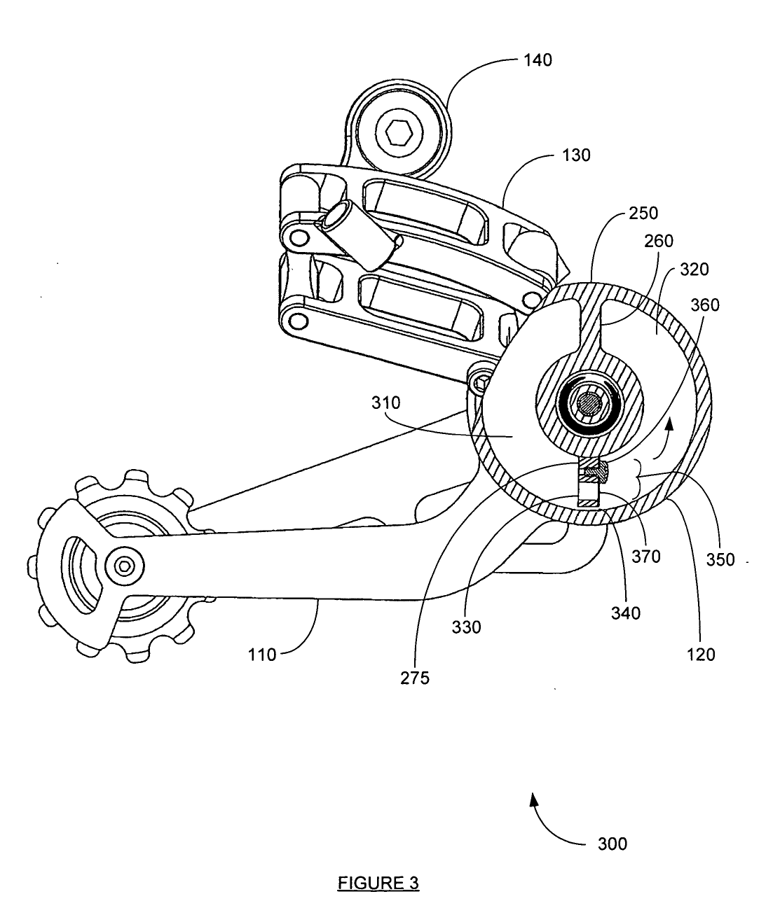

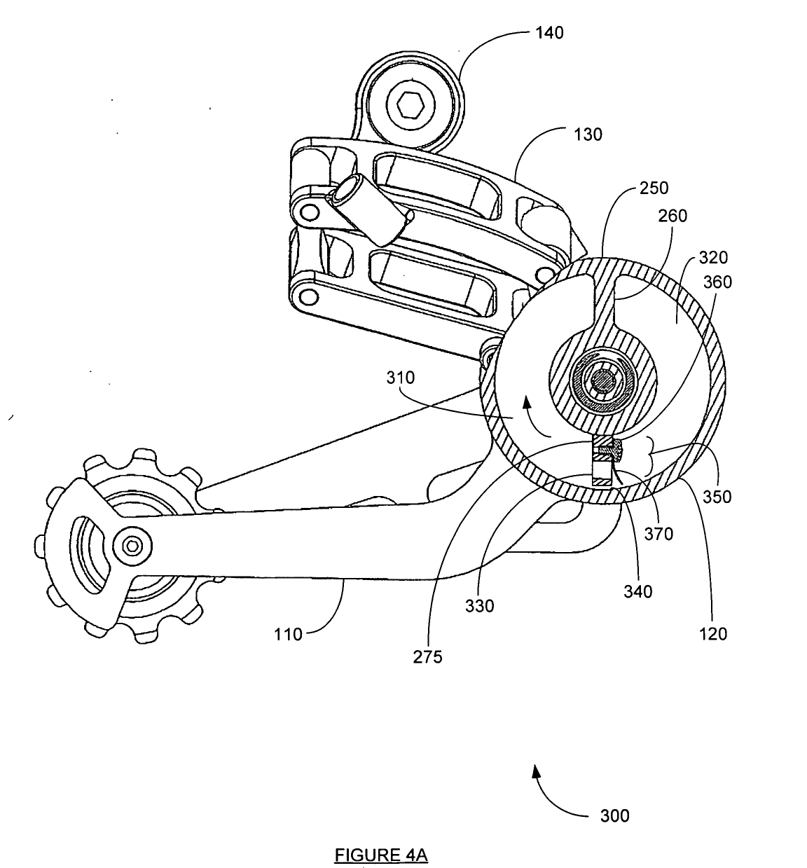

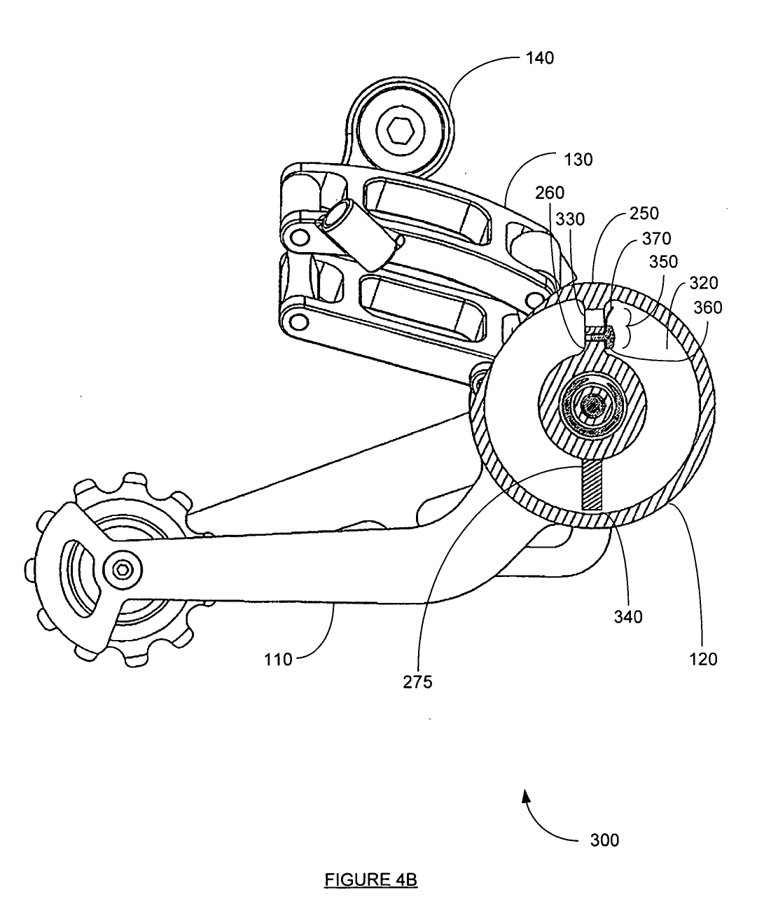

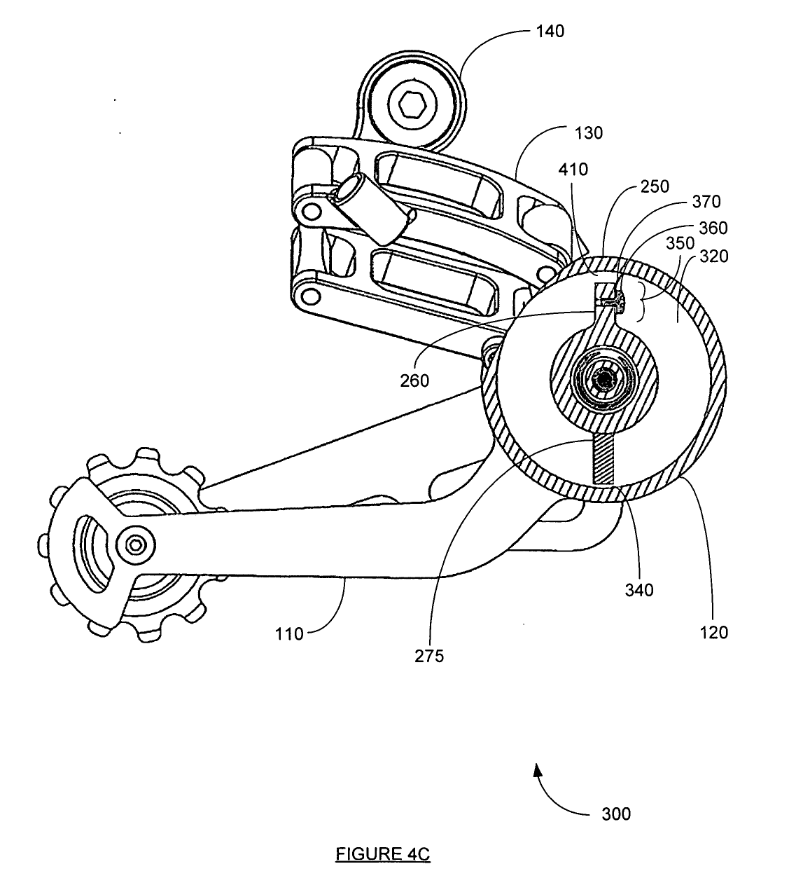

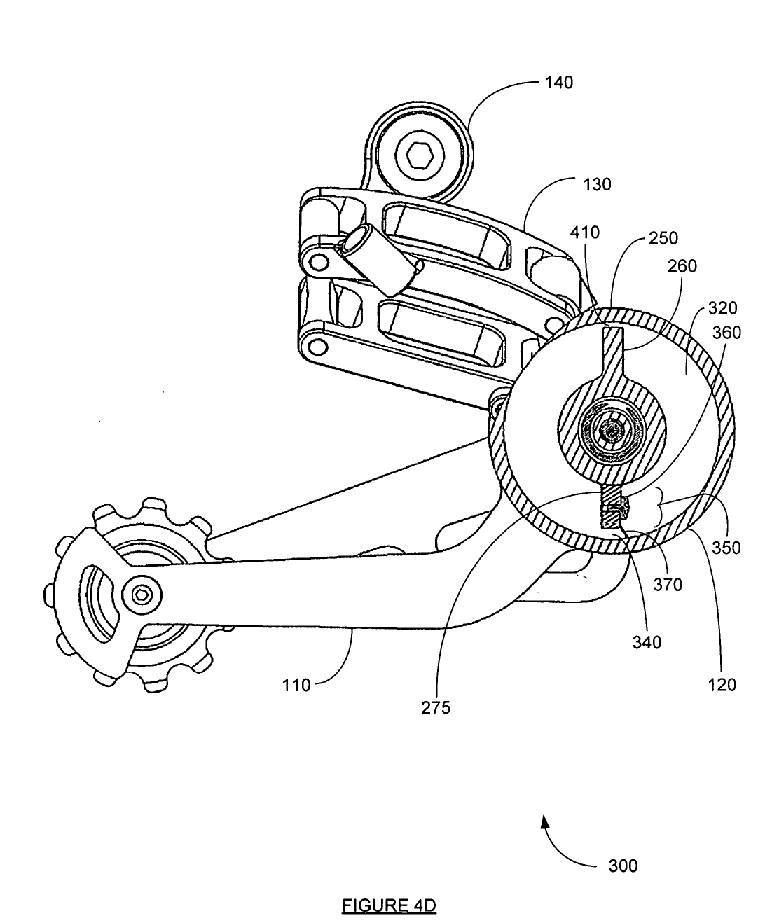

FIG. 3 and FIG. 4A show cross sectional views of an embodiment of a fluid dampening device 300 employing a one-way valve. Fluid dampening device 300 includes many elements that are similar to those found in chain tensioning system 100. For convenience of discussion, FIG. 3 and FIG. 4A will use the same reference numerals for those elements. In FIG. 3, knuckle boss 250 contains revolving web 275 and stationary web 260, thereby forming two chambers: a left chamber 310 and a right chamber 320. A fluid resides in both chambers. The revolving web 275 is shown with a cavity 330. Additionally, a breach 340 is shown around the revolving web 275. In this embodiment, when the revolving web 275 rotates in a counter-clockwise direction, fluid from the right chamber 320 flows through the breach 330 to the left chamber 310. A one-way valve 350, disposed across the cavity 330, does not permit fluid to flow through the cavity 330. The one-way valve 350 in this embodiment is a leaf valve made from a screw 360 inserted into the revolving web 275, and a mechanical leaf 370. Fluid flowing from the left chamber 310 to the right chamber 320 will force open the mechanical leaf 370. However, fluid attempting to flow from the right chamber 320 to the left chamber 310 will force the mechanical leaf 370 closed. As described above, one-way valve configurations other than a leaf valve may serve the same purposes as the one-way valve 350.

In FIG. 4A, clockwise rotation of the revolving web 275 in the previously discussed embodiment is shown. During clockwise rotation, the one-way valve 350 opens to allow fluid flow through the cavity 330 from the left chamber 310 to the right chamber 320. Additionally, fluid also flows through the breach 340. This embodiment may be used on a bicycle to allow the chain tensioning device 110 to adjust quickly during changing of sprockets, but slowly when the bicycle hits rough terrain causing over-rotation, primarily in one direction, of the chain tensioning device 110.

The embodiment shown in FIG. 3 and FIG. 4A provides more substantial fluid dampening when the revolving web 275 rotates in the counter-clockwise direction than when the revolving web 275 rotates in the clockwise direction. The size of the breach 340 and the cavity 330 may be configured to provide very little dampening in one direction while providing significant fluid dampening in the other direction. In a configuration where fluid dampening is provided for in both directions, a one-way valve 350 may not be employed.

FIG. 4B shows an embodiment of the fluid dampening device 300 similar to that shown in FIG. 4A, except having a breach 340 around the revolving web 275 and a cavity 330 with a one-way valve 350 in the stationary web 260. FIG. 4C shows another similar embodiment to that shown in FIG. 4A, except having a breach 340 around the revolving web 275 and a breach 410 around the stationary web 260, with a one-way valve 350 disposed across the breach 410 around the stationary web 260. FIG. 4D shows another similar embodiment to that shown in FIG. 4A, except having a breach 340 around the revolving web 275 and a breach 410 around the stationary web 260, with a one-way valve 350 disposed across the breach 340 around the revolving web 275. The embodiments shown in FIG. 4B, FIG. 4C and FIG. 4D may be used in a manner similar to the embodiment shown in FIG. 4A. These embodiments may provide more substantial dampening when the revolving web 275 rotates in the counter-clockwise direction than when the revolving web 275 rotates in the clockwise direction.

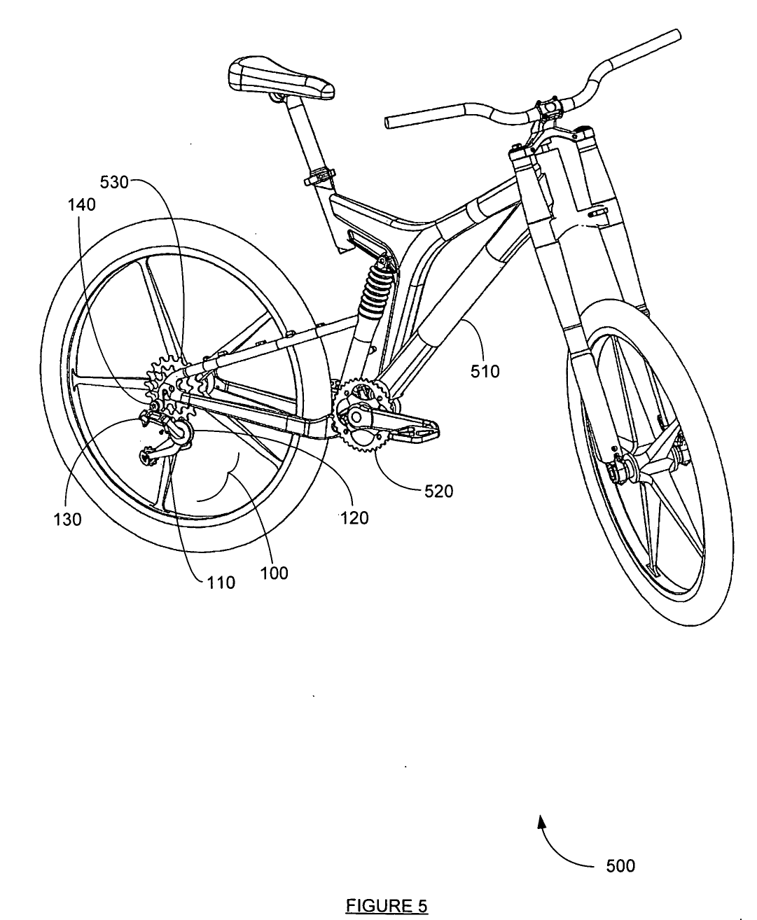

FIG. 5 shows the chain tensioning system 100 coupled to a bicycle frame 510 of a bicycle 500 using the mounting boss 140. The chain tensioning system 100 includes a chain tensioning device 110, fluid dampening device 120 and derailleur 130. In FIG. 5, a chain is not shown for clarity, but engages both a front sprocket 520 and one sprocket in a rear sprocket set 530, creating a multi-ratio transmission system. The chain also engages two sprockets in the chain tensioning system 100.

When a user of the bicycle 500 switches between gears in the rear sprocket set 530 by operating the derailleur 130, chain tension changes and the chain tensioning device 110 adjusts to take up or give out more chain slack. These chain tension changes occur relatively slowly, and the fluid dampening device 120 may not appreciably alter the reaction of the chain tensioning device 110. However, when the bicycle 500 encounters rough terrain, primarily upward forces on the bicycle 500 may be encountered due to the weight of the bicycle 500, the weight of the user, and the momentum of the bicycle 500. The inertia of the chain tensioning device 110 may cause the chain tensioning device 110 to quickly over-rotate downward in relation to the bicycle 500. In this situation, the fluid dampening device 120 prevents quick movement of the chain tensioning device 110, thereby preventing excess chain slack and the consequential adverse effects thereof.

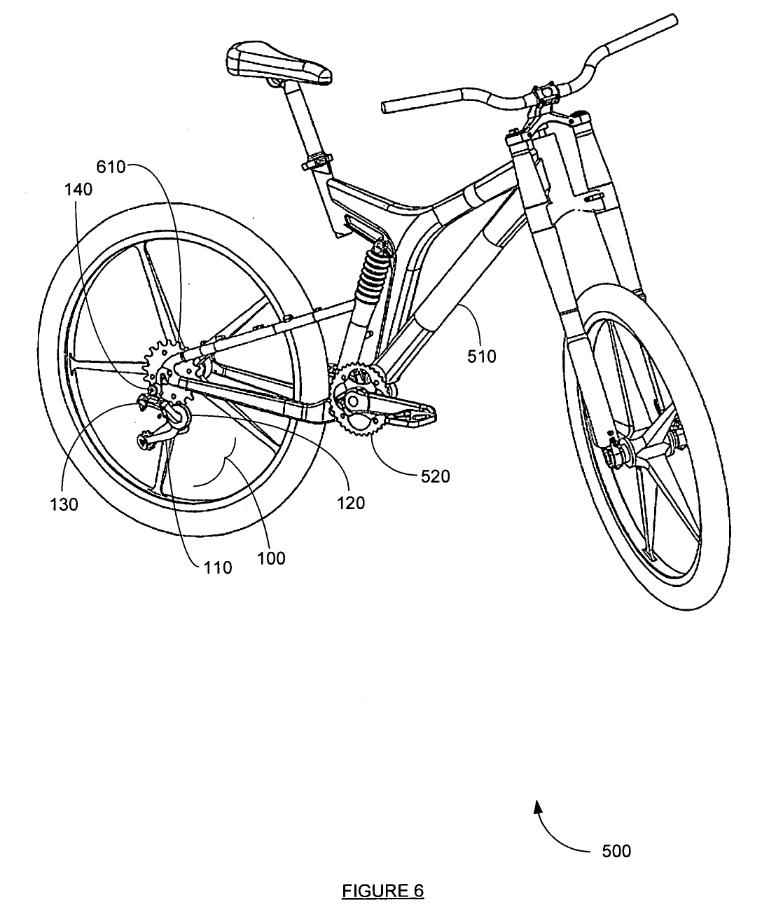

FIG. 6 shows an embodiment, similar to that shown in FIG. 5, except having a single-ratio transmission system. In this embodiment, instead of a rear sprocket set 530, a single rear sprocket 610 is used to create a single-ratio transmission system.

The invention has now been described in detail for purposes of clarity and understanding. However, it will be appreciated that certain changes and modifications may be practiced within the scope of the appended claims.

What is claimed is:

1. A chain tensioning system comprising:
a chain tensioning device configured to maintain tension on a chain; and
a fluid dampening device operably coupled to the chain tensioning device, wherein the fluid dampening system is configured to permit slow movement of the chain tensioning device while dampening sudden movement.

2. A system as in claim 1, wherein the chain tensioning device comprises:
a link arm assembly having at least one pulley which engages the chain; and
a spring configured to apply a force to the link arm assembly.

3. A system as in claim 1, wherein the fluid dampening device comprises:
a knuckle boss defining an annular groove for holding a fluid;
a stationary web within the annular groove;
a flange that covers the annular groove, and wherein the chain tensioning device is operably coupled to the flange so as to be able to rotate and vary the tension on the chain; and
a revolving web attached to the flange so as to be disposed within the annular groove, wherein the stationary web and the revolving web form at least two chambers within the annular groove, and wherein at least one of the stationary web and the revolving web define at least one fluid path configured to allow the fluid to flow from one of the chambers to at least one of the other chambers when the revolving web revolves through the annular groove.

4. A system as in claim 3, wherein the at least one fluid path comprises at least one of:
a cavity through the stationary web;
a cavity through the revolving web;
a breach around the stationary web;
a breach around the revolving web;
a one-way valve disposed across a cavity through the stationary web;
a one-way valve disposed across a cavity through the revolving web;
a one-way valve disposed across a breach around the stationary web; or
a one-way valve disposed across a breach around the revolving web.

5. A system as in claim 1, wherein the fluid dampening device is further configured to permit slow movement of the chain tensioning device while dampening sudden movement in one direction only.

6. A system as in claim 1, wherein the chain tensioning device is coupled to a single-ratio chain transmission.

7. A system as in claim 1, wherein the chain tensioning device is coupled to a multi-ratio chain transmission.

8. A system as in claim 1, further comprising a derailleur coupled to the chain tensioning device that is configured to move the chain between different sprockets when operated by a user.

9. A system as in claim 8, wherein the derailleur comprises:
a link arm assembly having at least one pulley which engages the chain; and
an articulator coupled to the link arm assembly, wherein the articulator is configured to move the link arm assembly, and wherein moving the link arm assembly moves the chain between different sprockets.

10. A system as in claim 9, wherein the articulator comprises:
a cable operable by the user; and
a parallelogram linkage operably coupled to the cable, wherein the linkage is configured to move the link arm assembly when a tensile force is applied to or removed from the cable.

11. A system as in claim 1, wherein the chain tensioning device is coupled to a mounting boss, and wherein the mounting boss is coupleable to a bicycle frame.

12. A chain derailleur tensioning system comprising:
a derailleur configured to move a chain between different sprockets;
a chain tensioning device coupled to the derailleur, wherein the chain tensioning device is configured to maintain tension on the chain; and
a fluid dampening device operably coupled to the chain tensioning device, wherein the fluid dampening system is configured to permit slow movement of the chain tensioning device while dampening sudden movement.

13. A system as in claim 12, wherein the fluid dampening device comprises:
a knuckle boss defining an annular groove for holding a fluid;
a stationary web within the annular groove;
a flange that covers the annular groove, and wherein the chain tensioning device is operably coupled to the flange so as to be able to rotate and vary the tension on the chain; and
a revolving web attached to the flange so as to be disposed within the annular groove, wherein the stationary web and the revolving web form at least two chambers within the annular groove, and wherein at least one of the stationary web and the revolving web define at least one fluid path configured to allow the fluid to flow from one of the chambers to at least one of the other chambers when the revolving web revolves through the annular groove.

14. A system as in claim 13, wherein the at least one fluid path comprises at least one of:
a cavity through the stationary web;
a cavity through the revolving web;
a breach around the stationary web;
a breach around the revolving web;
a one-way valve disposed across a cavity through the stationary web;
a one-way valve disposed across a cavity through the revolving web;
a one-way valve disposed across a breach around the stationary web; or
a one-way valve disposed across a breach around the revolving web.

15. A system as in claim 12, wherein the chain tensioning device is coupled to a mounting boss, and wherein the mounting boss is coupleable to a bicycle frame.

16. A chain tensioning system comprising:
a means for maintaining tension on a chain; and
a means for permitting slow changes in chain tension and dampening sudden changes in chain tension.

17. A system as in claim 16, further comprising a means for moving the chain between different sprockets.

18. A system as in claim 16, wherein the means for permitting slow changes in chain tension and dampening sudden changes in chain tension comprises:
a knuckle boss defining an annular groove for holding a fluid;
a stationary web within the annular groove;
a flange that covers the annular groove, and wherein the chain tensioning device is operably coupled to the flange so as to be able to rotate and vary the tension on the chain; and
a revolving web attached to the flange so as to be disposed within the annular groove, wherein the stationary web and the revolving web form at least two chambers within the annular groove, and wherein at least one of the stationary web and the revolving web define at least one fluid path configured to allow the fluid to flow from one of the chambers to at least one of the other chambers when the revolving web revolves through the annular groove.

19. A system as in claim 18, wherein the at least one fluid path comprises at least one of:
a cavity through the stationary web;
a cavity through the revolving web;
a breach around the stationary web;
a breach around the revolving web;
a one-way valve disposed across a cavity through the stationary web;
a one-way valve disposed across a cavity through the revolving web;
a one-way valve disposed across a breach around the stationary web; or
a one-way valve disposed across a breach around the revolving web.

20. A system as in claim 16, further comprising a means for permitting slow changes in chain tension and dampening sudden changes in chain tension in one direction only.

21. A fluid dampening system comprising a fluid dampening device coupleable to a chain tensioning device, wherein the chain tensioning device is configured to maintain tension on a chain, and wherein the fluid dampening device, when coupled to the chain tensioning device, is configured to permit slow movement of the chain tensioning device while dampening sudden movement.

22. A system as in claim 21, wherein the fluid dampening device is coupleable to the chain tensioning device by coupling a rotational flange on the fluid dampening device to the chain tensioning device.
